(19) United States
(12) Patent Application Publication
(10) Pub. No.: US 2025/0043159 A1
(43) Pub. Date: Feb. 6, 2025

(54) ELECTRICALLY CONDUCTIVE BONDING TAPE AND ELECTRONIC DEVICE INCLUDING THE SAME

(71) Applicant: 3M INNOVATIVE PROPERTIES COMPANY, St. Paul, MN (US)

(72) Inventors: Junbeom Shin, Hwaseong-si (KR); Jeongwan Choi, Suwon-Si (KR); Jong-Pil Kim, Gyeonggi-do (KR)

(21) Appl. No.: 18/714,865

(22) PCT Filed: Dec. 12, 2022
(86) PCT No.: PCT/IB2022/062084

§ 371 Date: May 30, 2024

(30) Foreign Application Priority Data
Dec. 16, 2021 (KR) 10-2021-0180277

(51) Int. Cl. C09J 9/02; C08K 3/08; C09J 7/21

(52) U.S. Cl. CPC C09J 9/02; C08K 3/08; C09J 7/21; C08K 2201/005; C09J 2203/326; C09J 2301/208; C09J 2301/314; C09J 2301/408; C09J 2400/243; C09J 2400/26

(57) ABSTRACT

The disclosure relates to an electrically conductive bonding tape and an electronic device including the same. Specifically, according to an embodiment of the disclosure, there is provided an electrically conductive bonding tape, including an electrically conductive first adhesive layer including opposing first and second major surfaces and electrically conductive along at least a thickness direction, the first adhesive layer having an average thickness t and including a substantially electrically insulative first adhesive material and pluralities of electrically conductive first and second particles dispersed in the first adhesive material, the first and second particles having respective average thickness t1 and t2, t1/t being 0.7-0.95 inclusive, t2/t being 0.2-0.7 inclusive.

### TECHNICAL FIELD

The disclosure relates to an electrically conductive bonding tape and an electronic device including the same.

### BACKGROUND

Recently, technology for mobile communication is being actively developed, and important factors for development of mobile communication are increasing a service capacity and enhancing communication quality. The increasing of the service capacity and the enhancement of the communication quality may be accompanied by a problem of inter-channel interference, and intermodulation distortion (IMD) may be an important factor of the interference problem.

When two or more signal frequencies interfere with each other, an unexpected parasitic signal may be generated. For example, a phenomenon in which signal frequencies interfere with each other and a parasitic signal is generated in a passive element is referred to as passive intermodulation (PIM).

Such passive intermodulation (PIM) occurs not only in a filter but also in most of passive elements having metal-to-metal contact, such as an antenna, a cable, a connector, a switch, or the like. In addition, the passive intermodulation (PIM) may occur due to loose mechanical bonding, oxidation on a bonding portion between ferrous-based metals, contamination on a surface of a conductor on RF welding, nonlinearity characteristics like hysteresis of a ferromagnetic material.

### SUMMARY

### Technical Problem

The passive intermodulation (PIM) phenomenon mostly occurs in a process of communicating data at high speed in a communication device, etc. However, when the passive intermodulation occurs, it may influence interference between an uplink channel signal and a downlink channel signal, causing a problem that a communication service radius is reduced or telephone connection efficiency is abruptly reduced. To this end, communication quality may deteriorate and inconvenience of a user may be caused.

An embodiment of the disclosure has been developed based on the above-described background, and provides an electrically conductive bonding tape which may reduce passive intermodulation (PIM) in order to enhance communication quality.

### Technical Solution

According to an aspect of the disclosure, there is provided an electrically conductive bonding tape, including: an electrically conductive first adhesive layer including opposing first and second major surfaces and electrically conductive along at least a thickness direction, the first adhesive layer having an average thickness t and including a substantially electrically insulative first adhesive material and pluralities of electrically conductive first and second particles dispersed in the first adhesive material, the first and second particles having respective average thickness t1 and t2, t1/t being 0.7-0.95 inclusive, t2/t being 0.2-0.7 inclusive; an electrically conductive second adhesive layer disposed on the first major surface of the first adhesive layer and electrically conductive along a thickness direction, the second adhesive layer including a substantially electrically insulative second adhesive material and a plurality of non-woven elongated electrically conductive fibers dispersed in the second adhesive material, the second adhesive layer penetrating the first adhesive layer so that at least some of the plurality of non-woven conductive fibers make physical contact with some of the plurality of first particles while 90%-99.5% inclusive of the plurality of non-woven conductive fibers do not reach the second major surface of the first adhesive layer; and an electrically conductive compressible spongy layer disposed on the second, opposite the first, major surface of the first adhesive layer and electrically conductive along at least a thickness direction, the spongy layer including an electrically conductive third material and a plurality of pores formed within the third material, wherein, in response to a first compressive force, the spongy layer compresses by about 30%-50% inclusive of a normal thickness of the spongy layer and regains about 60%-95% inclusive of a normal thickness of the spongy layer after the first compressive force is removed.

In addition, there is provided an electrically conductive bonding tape, including: an electrically conductive first adhesive layer including opposing first and second major surfaces and electrically conductive along at least a thickness direction, the first adhesive layer having an average thickness t and including a substantially electrically insulative first adhesive material, a plurality of electrically conductive first particles and a plurality of non-woven elongated fibers dispersed in the first adhesive material, the first particles having an average thickness t1, t1/t being 0.7-1.2 inclusive, the fibers having an average length d, d/t being 1.5-5 inclusive; and an electrically conductive compressible spongy layer disposed on the second, opposite the first, major surface of the first adhesive layer and electrically conductive along at least a thickness direction, the spongy layer including an electrically conductive third material and a plurality of pores formed within the third material, wherein, in response to a first compressive force, the spongy layer compresses by about 30%-50% inclusive of a normal thickness of the spongy layer and regains at least about 50%-95% inclusive of a normal thickness of the spongy layer after the first compressive force is removed.

### Advantageous Effects

An embodiment of the disclosure has an effect of enhancing communication quality by reducing passive intermodulation (PIM).

### BRIEF DESCRIPTION OF THE DRAWINGS

FIG. 1 is a schematic view of an electronic device according to a first embodiment of the disclosure;

FIG. 2 is a cross-sectional view of an electrically conductive bonding tape of FIG. 1;

FIG. 3 is an enlarged view of the A portion of FIG. 2; and

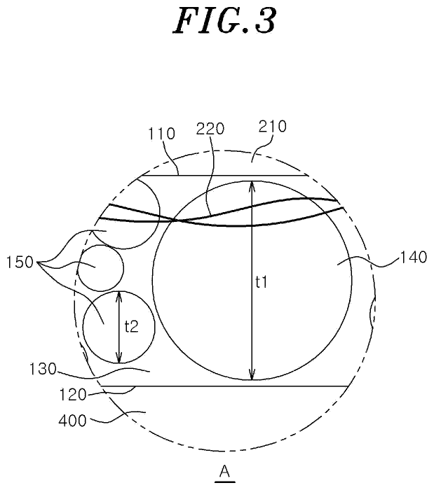

FIG. 4 is a cross-sectional view of an electrically conductive bonding tape according to a second embodiment of the disclosure.

### DETAILED DESCRIPTION

Hereinafter, specific embodiments for implementing the technical concept of the disclosure will be described in detail with reference to the accompanying drawings.

In the description of the disclosure, detailed explanations of related-art configurations or functions are omitted when it is deemed that they may unnecessarily obscure the essence of the disclosure.

In addition, it should be understood that, when a certain element is referred to as being ‘connected to,’ ‘making contact with,’ ‘coupled to’ another element, the certain element may be directly connected to, make contact with, or coupled to another element, but there may be an intervening element therebetween.

The terms used in the detailed descriptions are used for the purpose of describing particular embodiments only and are not intended to limit the disclosure. The singular forms include the plural forms as well unless the context clearly indicates otherwise.

In addition, throughout the description, the expression “upper side” or the like is described with reference to illustrations in the drawings, and it is to be noted that this may be expressed differently when the orientation of a corresponding object is changed. For the same reason, some element may be exaggerated, omitted or schematically illustrated in the drawings, and the size of each element does not entirely reflect a real size.

In addition, the terms including ordinal numbers such as ‘first’ and ‘second’ may be used to describe various elements, but these elements should not be limited by such terms. These terms are used for the purpose of distinguishing one element from another element only.

The term “includes” used in this specification specifies a specific feature, area, integer, step, operation, element, and/or component, and does not preclude the presence or addition of other specific features, areas, integers, steps, operations, elements, components, and/or groups.

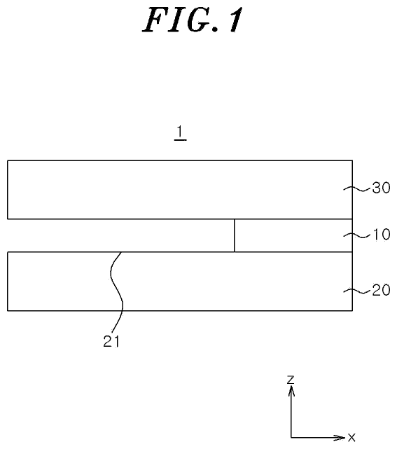

A thickness direction used in this specification may be a z-axis direction of FIGS. 1, 2, and 4.

Hereinafter, a detailed configuration of an electronic device 1 according to a first embodiment of the disclosure will be described with reference to the drawings.

Hereinafter, referring to FIG. 1, the electronic device 1 according to the first embodiment of the disclosure may be a mobile electronic device, and for example, may be a portable phone, a net book, a notebook, an UMPC, a tablet, a smartphone, etc. The electronic device 1 may include an electrically conductive bonding tape 10, a first electrically conductive component 20, and a second electrically conductive component 30.

The electrically conductive bonding tape 10 may be disposed between the first electrically conductive component 20 and the second electrically conductive component 30, and may bond the first electrically conductive component 20 and the second electrically conductive component 30. In addition, the electrically conductive bonding tape 10 may electrically connect the first electrically conductive component 20 and the second electrically conductive component 30.

The electrically conductive bonding tape 10 may reduce passive intermodulation (PIM) occurring in the electronic device 1. Herein, the passive intermodulation is related to electro magnetic interference (EMI) that influences an RF signal of an antenna, etc., and may degrade communication quality. The electrically conductive bonding tape 10 may enhance communication quality by reducing passive intermodulation occurring in the electronic device 1.

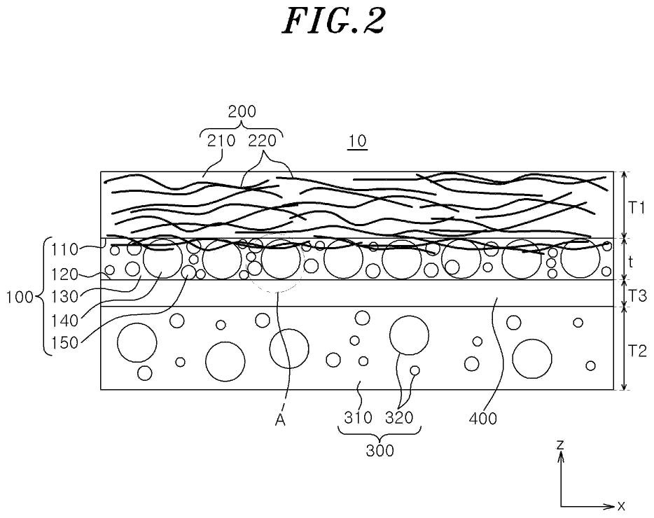

Referring to FIG. 2, the electrically conductive bonding tape 10 may include a first adhesive layer 100, a second adhesive layer 200, a spongy layer 300, and a carrier layer 400.

The first adhesive layer 100 may be disposed between the second adhesive layer 200 and the carrier layer 400, and may bond the second adhesive layer 200 and the carrier layer 400. The first adhesive layer 100 may electrically connect the second adhesive layer 200 and the carrier layer 400. In addition, the first adhesive layer 100 may have an average thickness t and may be electrically conductive along at least a thickness direction. Herein, the average thickness t refers to an average of a thickness between a first major surface 100 and a second major surface 120. For example, the average thickness t of the first adhesive layer 100 may be 5 microns-30 microns inclusive. The first adhesive layer 100 may include the first major surface 110 and the second major surface 120.

The first major surface 110 and the second major surface 120 may be both side surfaces in the thickness direction. In other words, the first major surface 110 and the second major surface 120 may be formed on the opposite sides in the thickness direction and may face each other. The first major surface 110 may be connected with the second adhesive layer 200, and the second major surface 120 may be connected with the carrier layer 400.

The first adhesive layer 100 may further include a first adhesive material 130, a first particle 140 and a second particle 150.

The first adhesive material 130 may form one layer while containing a plurality of first particles 140 and a plurality of second particles 150. The first adhesive material 130 may be substantially electrically insulative. For example, the first adhesive material 130 may include one or more of a pressure sensitive adhesive, a hot melt adhesive, a thermoset adhesive, a thermoplastic adhesive, a UV adhesive, a liquid adhesive, a solvent based adhesive, and a water based adhesive. In addition, the first adhesive material 130 may include one or more of an acrylate, a methacrylate, an epoxy, a polyurethane, a polyester, a urethane, a polycarbonate, and polysiloxane.

The first particle 140 may be an electrically conductive particle. A plurality of first particle 140 may be provided, and the plurality of first particles 140 may be dispersed in the first adhesive material 130. For example, the plurality of first particles 140 may be dispersed in the electrically insulative first adhesive material 140, so that the first adhesive layer 100 has electrical conductivity. In addition, the first particle 140 may include a metal, and for example, the metal may include one or more of silver, gold, aluminum, and nickel.

Referring to FIG. 2, the plurality of first particles 140 may have an average thickness t1. Herein, the thickness of the first particle 140 may refer to a diameter of the first particle 140 when the first particle 140 has a spherical shape. For example, t1 may have a thickness of greater than 5 microns and less than or equal to 35 microns. More specifically, t1 may have a thickness of 25-35 microns inclusive. In addition, t1/t which is a ratio of the average thickness of the first particle 140 to the average thickness of the first adhesive layer 100 may be 0.7-0.95 inclusive.

The second particle 150 may be an electrically conductive particle. A plurality of second particles 150 may be provided, and the plurality of second particles 150 may be dispersed in the first adhesive material 130. For example, the plurality of second particles 150 may be dispersed in the electrically insulative first adhesive material 130, so that the first adhesive layer 100 has electrical conductivity. In addition, the second particle 150 may include a metal, and for example, the metal may include one or more of silver, gold, aluminum, and nickel.

The plurality of second particles 150 may have an average thickness t2. Herein, the thickness of the second particle 150 may refer to a diameter of the second particle 150 when the second particle 150 has a spherical shape. For example, t2 may have a thickness of greater than or equal to 5 microns and less than 20 microns. More specifically, t2 may have a thickness of 5-15 microns inclusive. In addition, t2/t which is a ratio of the average thickness of the second particle 150 to the average thickness of the first adhesive layer 100 may be 0.2-0.7 inclusive.

The second adhesive layer 200 may provide an electrical passage of a wider range than the first adhesive layer 100. In addition, the second adhesive layer 200 may be disposed on the first major surface 110 of the first adhesive layer 100. In other words, the second adhesive layer 200 may be disposed on an upper side of the first adhesive layer 100. In addition, the second adhesive layer 200 may have an average thickness T1 and may be electrically conductive along at least the thickness direction. For example, the average thickness T1 of the second adhesive layer 200 may be 15-50 microns inclusive. The second adhesive layer 200 may include a second adhesive material 210 and a non-woven conductive fiber 220.

The second adhesive material 210 may form one layer while containing a plurality of non-woven conductive fibers 220. The second adhesive material 210 may be substantially electrically insulative. For example, the second adhesive material 210 may include one or more of a pressure sensitive adhesive, a hot melt adhesive, a thermoset adhesive, a thermoplastic adhesive, a UV adhesive, a liquid adhesive, a solvent based adhesive, and a water based adhesive. In addition, the second adhesive material 210 may include one or more of an acrylate, a methacrylate, an epoxy, a polyurethane, a polyester, a urethane, a polycarbonate, and polysiloxane.

The non-woven conductive fiber 220 may be an electrically conductive fiber. A plurality of non-woven conductive fibers 220 may be provided, and the plurality of non-woven conductive fibers 220 may be dispersed in the second adhesive material 210. For example, the plurality of non-woven conductive fibers 220 may be dispersed in the electrically insulative second adhesive material 210, so that the second adhesive layer 200 has electrical conductivity. In addition, the non-woven conductive fiber 220 may be a non-woven elongated fiber that has a predetermined length.

The non-woven conductive fiber 220 may include a metal-coated insulative fiber. In this case, the non-woven conductive fiber 220 may have electrical conductivity by coating an insulative fiber with a metal. For example, the metal coated over the non-woven conductive fiber 220 may include one or more of silver, gold, aluminum, and nickel.

In addition, the plurality of non-woven conductive fibers 220 may penetrate the first adhesive layer 100, so that at least some of the non-woven conductive fibers make physical contact with some of the plurality of first particles 140. Herein, the non-woven conductive fiber 220 penetrating the first adhesive layer 100 may be a concept including not only the non-woven conductive fiber 220 being embedded in the first adhesive layer 100 but also only one side penetrating into the first adhesive layer 100. For example, the non-woven conductive fiber 220 may penetrate the first major surface 110 of the first adhesive layer 100, but may not reach the second major surface 120. In addition, 90%-99.5% inclusive of the plurality of non-woven conductive fibers 220 may penetrate the first adhesive layer 100, but may not reach the second major surface 120 of the first adhesive layer 100.

The second adhesive layer 200 may be a continuous layer with the first adhesive layer 100. For example, some of the plurality of non-woven conductive fibers 220 of the second adhesive layer 200 may penetrate the first adhesive layer 100, so that the second adhesive layer 200 and the first adhesive layer 100 are not separated from each other and are continuously formed with each other. In this case, t+T1 which is a sum of the thicknesses of the first adhesive layer 100 and the second adhesive layer 200 may be 20-80 microns inclusive.

The spongy layer 300 may absorb an impact applied to the electrically conductive bonding tape 10. The spongy layer 300 may be disposed on the second major surface 120 of the first adhesive layer 100 which is the opposite surface of the first major surface 110. Herein, the spongy layer 300 being disposed on the second major surface 120 may be a concept including not only the spongy layer 300 being placed in direct contact with the second major surface 120, but also a different layer being interposed between the second major surface 120 and the spongy layer 300. The spongy layer 300 may have an average thickness T2, and the average thickness T2 of the spongy layer 300 may be 0.2-3.0 mm inclusive.

In addition, the spongy layer 300 may be electrically conductive along the thickness direction, and may have compressibility. For example, when a predetermined first compressive force is applied to the spongy layer 300, the spongy layer 300 may compress, and, when the applied first compressive force is removed, the spongy layer 300 may regain. More specifically, when the first compressive force is applied, the spongy layer 300 compresses by about 30%-50% inclusive of a thickness before the first compressive force is applied. In addition, after the first compressive force applied to the spongy layer 300 is removed, the spongy layer 300 may regain by about 60%-95% inclusive of a thickness before the first compressive force is applied to the spongy layer 300. As described above, the spongy layer 300 may have an excellent restoring force.

The spongy layer 300 may include a third material 310 and a pore 320.

The third material 310 may form one layer while containing a plurality of pores 320. The third material 310 may have electrical conductivity along the thickness direction. In addition, the third material 310 may include a metal-coated insulative material. For example, the insulative material of the third material 310 may include one or more of polyurethane, polypropylene, polyethylene polyvinyl chloride, polyether and polyester. In addition, the metal coated over the insulative material of the third material 310 may include one or more of copper, silver, gold, aluminum, and nickel.

A plurality of pores 320 may be provided, and the plurality of pores 320 may be included within the third material 310. The pore 320 may have a predetermined volume, and a total volume of the plurality of pores may be about 40%-80% inclusive of a total volume of the spongy layer 300.

The carrier layer 400 may be disposed between the first adhesive layer 100 and the spongy layer 300, and may connect the first adhesive layer 100 and the spongy layer 300. In addition, the carrier layer 400 may support the spongy layer 300. The carrier layer 400 may have a predetermined thickness T3, and the thickness T3 of the carrier layer 400 may be 20-200 microns inclusive. In addition, the carrier layer 400 may have, for example, a mesh structure or a fabric structure.

The first electrically conductive component 20 may provide a circuit through which a current flows. For example, the first electrically conductive component 20 may be a flexible printed circuit board (FPCB) substrate, and the first electrically conductive component 20 may include one or more of stainless steel and aluminum. In addition, the first electrically conductive component 20 may include a conductive outermost surface 21 that makes physical contact with and electrical contact with the electrically conductive bonding tape 10. The first electrically conductive component 20 may be electrically connected with the electrically conductive bonding tape 10 through the conductive outermost surface 21.

The second electrically conductive component 30 may provide a circuit through which a current flows. For example, the second electrically conductive component 30 may be a flexible printed circuit board (FPCB) substrate, and the second electrically conductive component 30 may include one or more of stainless steel and aluminum. In addition, the second electrically conductive component 30 may make physical and electrical contact with the electrically conductive bonding tape 10.

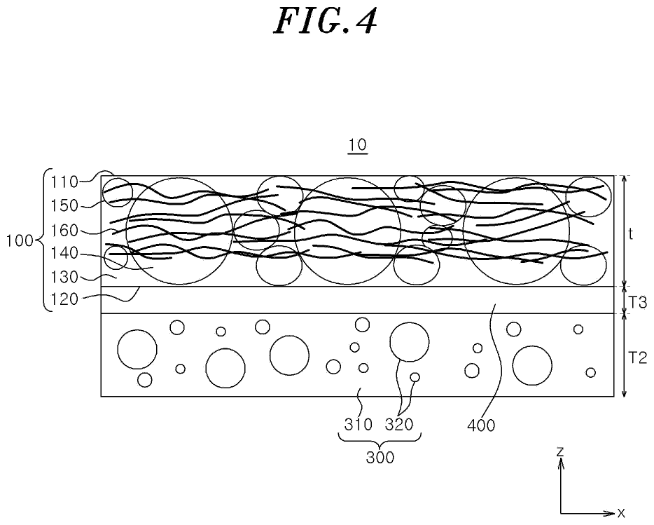

In addition to such a configuration, the first adhesive layer 100 according to a second embodiment of the disclosure may further include a non-woven fiber 160. Hereinafter, the second embodiment of the disclosure will be described by referring more to FIG. 4. In explaining the second embodiment, differences from the above-described embodiment will be highlighted, and, regarding the same descriptions and reference numerals, references are made to the above-described embodiment.

An electrically conductive bonding tape 10 according to the second embodiment of the disclosure may include a first adhesive layer 100, a spongy layer 300, and a carrier layer 400.

The first adhesive layer 100 may have an average thickness t, and may be electrically conductive along at least a thickness direction. For example, the average thickness t of the first adhesive layer 100 may be 15-50 microns inclusive. The first adhesive layer 100 may include a first major surface 110, a second major surface 120, a first adhesive material 130, a first particle 140, a second particle 150, and a non-woven fiber 160.

The first particle 140 and the second particle 150 may be electrically conductive. In addition, a plurality of first particles 140 and a plurality of second particles 150 may be provided, and the plurality of first particles 140 and the plurality of second particles 150 may be dispersed in the first adhesive material 130. For example, the first particle 140 may have an average thickness t1, and t1/t which is a ratio of the average thickness of the first particle 140 to the average thickness of the first adhesive layer 100 may be 0.7-1.2 inclusive. In addition, the second particle 150 may have an average thickness t2, and t2/t which is a ratio of the average thickness of the second particle 150 to the average thickness of the first adhesive layer 100 may be 0.2-0.7 inclusive.

A plurality of non-woven fibers 160 may be provided, and the plurality of non-woven fibers 160 may be dispersed in the first adhesive layer 100. The non-woven fiber 160 may be a non-woven elongated fiber which has a predetermined length. In addition, the plurality of non-woven fibers 160 may have an average length d. For example, d/t which is a ratio of the average length d of the plurality of non-woven fibers 160 to the thickness t of the first adhesive layer 100 may be 1.5-5 inclusive.

In addition, at least some of the plurality of non-woven fibers 160 may be electrically conductive. For example, all of the plurality of non-woven fibers 160 may have electrical conductivity. However, this is merely an example, and all of the plurality of non-woven fibers 160 may be electrically insulative.

The plurality of non-woven fibers 160 may penetrate the first adhesive layer 100, so that at least some of the non-woven fibers make physical contact with some of the plurality of first particles 140. In addition, the plurality of non-woven fibers 160 may penetrate the first adhesive layer 100, so that at least some of the non-woven fibers make physical contact with some of the plurality of second particles 150. The plurality of non-woven fibers 160 may not reach the second major surface 120 of the first adhesive layer 100. For example, 90%-99.5% inclusive of the plurality of non-woven fibers 160 may not reach the second major surface 120 of the first adhesive layer 100.

The spongy layer 300 may be disposed on the second major surface 120 of the first adhesive layer 100 which is the opposite surface of the first major surface 110. In addition, the spongy layer 300 may be electrically conductive along the thickness direction, and may have compressibility. For example, when a predetermined first compressive force is applied to the spongy layer 300, the spongy layer 300 may compress, and, when the applied first compressive force is removed, the spongy layer 300 may regain. More specifically, when the first compressive force is applied, the spongy layer 300 compresses by about 30%-50% inclusive of a thickness before the first compressive force is applied. In addition, after the first compressive force applied to the spongy layer 300 is removed, the spongy layer 300 may regain by about 50%-95% inclusive of a thickness before the first compressive force is applied to the spongy layer 300. The spongy layer 300 may include a third material 310 and a pore 320.

The following is a list of embodiments of present disclosure.

Item 1 relates to an electrically conductive bonding tape including: an electrically conductive first adhesive layer including opposing first and second major surfaces and electrically conductive along at least a thickness direction, the first adhesive layer having an average thickness t and including a substantially electrically insulative first adhesive material and pluralities of electrically conductive first and second particles dispersed in the first adhesive material, the first and second particles having respective average thickness t1 and t2, t1/t being 0.7-0.95 inclusive, t2/t being 0.2-0.7 inclusive; an electrically conductive second adhesive layer disposed on the first major surface of the first adhesive layer and electrically conductive along a thickness direction, the second adhesive layer including a substantially electrically insulative second adhesive material and a plurality of non-woven elongated electrically conductive fibers dispersed in the second adhesive material, the second adhesive layer penetrating the first adhesive layer so that at least some of the plurality of non-woven conductive fibers make physical contact with some of the plurality of first particles while 90%-99.5% inclusive of the plurality of non-woven conductive fibers do not reach the second major surface of the first adhesive layer; and an electrically conductive compressible spongy layer disposed on the second, opposite the first, major surface of the first adhesive layer and electrically conductive along at least a thickness direction, the spongy layer including an electrically conductive third material and a plurality of pores formed within the third material, wherein, in response to a first compressive force, the spongy layer compresses by about 30%-50% inclusive of a normal thickness of the spongy layer and regains about 60%-95% inclusive of a normal thickness of the spongy layer after the first compressive force is removed.

Item 2 relates to the electrically conductive bonding tape, wherein at least one of the first and second adhesive materials includes one or more of a pressure sensitive adhesive, a hot melt adhesive, a thermoset adhesive, a thermoplastic adhesive, a UV adhesive, a liquid adhesive, a solvent based adhesive, and a water based adhesive.

Item 3 relates to the electrically conductive bonding tape, wherein at least one of the first and second adhesive materials includes one or more of an acrylate, a methacrylate, an epoxy, a polyurethane, a polyester, a urethane, a polycarbonate, and polysiloxane.

Item 4 relates to the electrically conductive bonding tape, wherein the plurality of electrically conductive first particles include a metal.

Item 5 relates to the electrically conductive bonding tape, wherein the metal includes one or more of silver, gold, aluminum and nickel.

Item 6 relates to the electrically conductive bonding tape, wherein t1 is greater than about 5 microns and is less than or equal to about 35 microns.

Item 7 relates to the electrically conductive bonding tape, wherein the plurality of electrically conductive second particles include a metal.

Item 8 relates to the electrically conductive bonding tape, wherein the metal includes one or more of silver, gold, aluminum and nickel.

Item 9 relates to the electrically conductive bonding tape, wherein t2 is greater than or equal to about 5 microns and is less than about 20 microns.

Item 10 relates to the electrically conductive bonding tape, wherein the plurality of non-woven conductive fibers include metal-coated insulative fibers.

Item 11 relates to the electrically conductive bonding tape, wherein the metal includes one or more of silver, gold, aluminum and nickel.

Item 12 relates to the electrically conductive bonding tape, wherein the electrically conductive third material includes a metal-coated insulative material.

Item 13 relates to the electrically conductive bonding tape, wherein the metal includes one or more of copper, silver, gold, aluminum and nickel.

Item 14 relates to the electrically conductive bonding tape, wherein the insulative material includes one or more of polyurethane, polypropylene, polyethylene polyvinyl chloride, polyether and polyester.

Item 15 relates to the electrically conductive bonding tape, wherein a total volume of the plurality of pores is about 40%-80% inclusive of a total volume of the spongy layer.

Item 16 relates to an electronic device including: first and second electrically conductive components; and the electrically conductive bonding tape of claim 1 disposed between, and bonding and electrically connecting, the first and second electrically conductive components.

Item 17 relates to the electronic device, wherein at least one of the first and second electrically conductive components includes an electrically conductive outermost surface that makes electrical and physical contact with the electrically conductive bonding tape and includes one or more of stainless steel and aluminum.

Item 18 relates to the electronic device which is a mobile electronic device.

Item 19 relates to the electronic device, wherein the mobile electronic device is a mobile phone.

Item 20 relates to an electrically conductive bonding tape including: an electrically conductive first adhesive layer including opposing first and second major surfaces and electrically conductive along at least a thickness direction, the first adhesive layer having an average thickness t and including a substantially electrically insulative first adhesive material, a plurality of electrically conductive first particles and a plurality of non-woven elongated fibers dispersed in the first adhesive material, the first particles having an average thickness t1, t1/t being 0.7-1.2 inclusive, the fibers having an average length d, d/t being 1.5-5 inclusive; and an electrically conductive compressible spongy layer disposed on the second, opposite the first, major surface of the first adhesive layer and electrically conductive along at least a thickness direction, the spongy layer including an electrically conductive third material and a plurality of pores formed within the third material, wherein, in response to a first compressive force, the spongy layer compresses by about 30%-50% inclusive of a normal thickness of the spongy layer and regains at least about 50%-95% inclusive of a normal thickness of the spongy layer after the first compressive force is removed.

Item 21 relates to the electrically conductive bonding tape, wherein the first adhesive layer includes a plurality of electrically conductive second particles dispersed in the first adhesive material and having an average thickness t2, and wherein t2/t is 0.2-0.7 inclusive.

Item 22 relates to the electrically conductive bonding tape, wherein some of the plurality of non-woven elongated fibers are electrically conductive.

Item 23 relates to the electrically conductive bonding tape, wherein each of the plurality of non-woven fibers makes physical contact with at least one of the plurality of first particles.

Item 24 relates to the electrically conductive bonding tape, wherein at least 90%-99.5% inclusive of the plurality of non-woven fibers do not reach the second major surface of the first adhesive layer.

Although embodiments of the disclosure have been described in the form of specific embodiments, these are merely examples and the disclosure is not limited thereto, and should be interpreted as having the widest scope of the technical concept disclosed in the specification. An ordinary skilled person in the related art may embody a pattern of a shape that is not set forth herein by combining/substituting the disclosed embodiments, without departing from the scope of the disclosure. In addition, an ordinary skilled person in the related art may easily change or modify the disclosed embodiments based on the detailed descriptions, and it is obvious that the changes or modifications belong to the right scope of the disclosure.

Description of Reference Numerals

| | |
|---|---|
| 1: Electronic device | 10: Electrically conductive |
| | bonding tape |
| 20: First electrically | 30: Second electrically |
| conductive component | conductive component |
| 100: First adhesive layer | 110: First major surface |
| 120: Second major surface | 130: First adhesive material |
| 140: First particle | 150: Second particle |
| 160: Fiber | 200: second adhesive layer |
| 210: Second adhesive material | 220: Non-woven conductive fiber |
| 300: Spongy layer | 310: Third material |
| 320: Pore | |

1. An electrically conductive bonding tape comprising:
an electrically conductive first adhesive layer comprising opposing first and second major surfaces and electrically conductive along at least a thickness direction, the first adhesive layer having an average thickness t and comprising a substantially electrically insulative first adhesive material and pluralities of electrically conductive first and second particles dispersed in the first adhesive material, the first and second particles having respective average thickness t1 and t2, t1/t being 0.7-0.95 inclusive, t2/t being 0.2-0.7 inclusive;
an electrically conductive second adhesive layer disposed on the first major surface of the first adhesive layer and electrically conductive along a thickness direction, the second adhesive layer comprising a substantially electrically insulative second adhesive material and a plurality of non-woven elongated electrically conductive fibers dispersed in the second adhesive material, the second adhesive layer penetrating the first adhesive layer so that at least some of the plurality of non-woven conductive fibers make physical contact with some of the plurality of first particles while 90%-99.5% inclusive of the plurality of non-woven conductive fibers do not reach the second major surface of the first adhesive layer; and
an electrically conductive compressible spongy layer disposed on the second, opposite the first, major surface of the first adhesive layer and electrically conductive along at least a thickness direction, the spongy layer comprising an electrically conductive third material and a plurality of pores formed within the third material,
wherein, in response to a first compressive force, the spongy layer compresses by about 30%-50% inclusive of a normal thickness of the spongy layer and regains about 60%-95% inclusive of a normal thickness of the spongy layer after the first compressive force is removed.

2. The electrically conductive bonding tape of claim 1,
wherein the plurality of electrically conductive first particles comprise a metal.

3. The electrically conductive bonding tape of claim 1,
wherein t1 is greater than about 5 microns and is less than or equal to about 35 microns.

4. The electrically conductive bonding tape of claim 1,
wherein t2 is greater than or equal to about 5 microns and is less than about 20 microns.

5. The electrically conductive bonding tape of claim 1,
wherein the plurality of non-woven conductive fibers comprise metal-coated insulative fibers.

6. The electrically conductive bonding tape of claim 1,
wherein the electrically conductive third material comprises a metal-coated insulative material.

7. The electrically conductive bonding tape of claim 1,
wherein a total volume of the plurality of pores is about 40%-80% inclusive of a total volume of the spongy layer.

8. An electronic device comprising:
first and second electrically conductive components; and
the electrically conductive bonding tape of claim 1 disposed between, and bonding and electrically connecting, the first and second electrically conductive components.

9. The electronic device of claim 8,
wherein at least one of the first and second electrically conductive components comprises an electrically conductive outermost surface that makes electrical and physical contact with the electrically conductive bonding tape and comprises one or more of stainless steel and aluminum.

10. The electronic device of claim 48,
wherein the mobile electronic device is a mobile phone.

11. An electrically conductive bonding tape comprising:
an electrically conductive first adhesive layer comprising opposing first and second major surfaces and electrically conductive along at least a thickness direction, the first adhesive layer having an average thickness t and comprising a substantially electrically insulative first adhesive material, a plurality of electrically conductive first particles and a plurality of non-woven elongated fibers dispersed in the first adhesive material, the first particles having an average thickness t1, t1/t being 0.7-1.2 inclusive, the fibers having an average length d, d/t being 1.5-5 inclusive; and
an electrically conductive compressible spongy layer disposed on the second, opposite the first, major surface of the first adhesive layer and electrically conductive along at least a thickness direction, the spongy layer comprising an electrically conductive third material and a plurality of pores formed within the third material,
wherein, in response to a first compressive force, the spongy layer compresses by about 30%-50% inclusive of a normal thickness of the spongy layer and regains at least about 50%-95% inclusive of a normal thickness of the spongy layer after the first compressive force is removed.

12. The electrically conductive bonding tape of claim 11,
wherein the first adhesive layer comprises
a plurality of electrically conductive second particles dispersed in the first adhesive material and having an average thickness t2, and
wherein t2/t is 0.2-0.7 inclusive.

13. The electrically conductive bonding tape of claim 11,
wherein some of the plurality of non-woven elongated fibers are electrically conductive.

14. The electrically conductive bonding tape of claim 11,
wherein each of the plurality of non-woven fibers makes physical contact with at least one of the plurality of first particles.

15. The electrically conductive bonding tape of claim 11,
wherein at least 90%-99.5% inclusive of the plurality of non-woven fibers do not reach the second major surface of the first adhesive layer.
